(19) United States
(12) Patent Application Publication
(10) Pub. No.: US 2011/0307385 A1
(43) Pub. Date: Dec. 15, 2011

(54) CONTENT CONVERSION TRACKING

(75) Inventors: Jason James St. Pierre, Palo Alto, CA (US); Ravikiran Chittari, Acton, MA (US); Kenley Sun, Cambridge, MA (US)

(73) Assignee: Apple Inc., Cupertino, CA (US)

(21) Appl. No.: 12/815,395

(22) Filed: Jun. 14, 2010

(51) Int. Cl. G06Q 30/00; G06Q 50/00; G06F 15/16; G06Q 10/00

(52) U.S. Cl. 705/52; 709/217; 705/27.1; 705/26.1

(57) ABSTRACT

The present technology allows reliable and accurate tracking of conversions of invitational content by storing token identifying items of invitational content presented to the user within a cookie jar of a local occurrence of an online-store application. When a purchase or download is made from the online store, the cookies are sent to the online store, which can match the purchase or download with the tokens. Thus, conversions can be tracked as they are completed.

### BACKGROUND

1. Technical Field

The present disclosure relates to electronic content delivery and more specifically to tracking user actions taken in response to presenting a user with invitational content.

2. Introduction

Content providers and content delivery networks have developed many techniques to analyze how a user interacts with the provided content. Often the content providers and content delivery networks work together to determine if the content was ignored or viewed, and if viewed did the user interact with the content. To gather this data content providers and content delivery networks developed complex schemes and had to modify content to include digital watermarks, or other computer code to report the data back to the content provider and content delivery network. However, such methods required a great degree of collaboration and coordination amongst content providers, content developers, content hosts, content delivery networks, etc. Even with such collaboration, users can thwart the effort with increased privacy settings or by ignoring the content when provided and later acting based on it without revisiting the content. Such difficulties made the analysis of how the user interacts with provided content incomplete and often inaccurate since the analysis also requires many assumptions, which are not always accurate. Accordingly, improved methods of reporting data regarding user interaction statistics and methods to gather more accurate data are needed.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The presently disclosed technology includes methods and systems for detailed and accurate tracking of conversions of invitational content that has been presented to a user into a desired action, such as a downloads or purchases of a media items.

When an item of invitational content is requested by a user terminal, a content delivery system can determine which item of invitational content to provide to the user terminal. In requesting an item of invitational content, the user terminal can include a device ID or possibly a user ID along with additional information that can identify an item of primary content running on the user terminal that is requesting the invitational content. The content delivery system can make a determination of which item of informational content to send to the client terminal using the device or user ID information and the primary content identity along with many other potential data points known to the content delivery system.

When the content delivery system sends an item of informational content to the client device, it can also send a token. The token can include information which identifies the item of invitational content such as an identification code(s). The identification code(s) included in the token can identify if the item of informational content is associated with other similar items of informational content (such as an advertisement campaign of similarly themed advertisements) and can identify the specific item of informational content (such as a particular impression of an advertisement with the advertisement campaign).

When the informational content is received by the client terminal, the client terminal can store the token and present the informational content. Often the informational content will be presented in association with some other primary content. The informational content invites a user to perform an action. As an example, the informational content invites a user to purchase a song from an online store. In such an instance, the informational content will have a link embedded therein which can direct a user to a local occurrence of an online store and specifically to the song with the online store. The link is a direct link to the content within the online store.

The local occurrence of the online store can be an application running on the client terminal that is provided by or associated with the online store. It can be as simple as an HyperText Markup Language (HTML) application presenting online content from the online store, or it can be a more involved application. When the user clicks on invitational content, the user is taken directly to the item in the online store; the token is also sent to the local occurrence of the online store and is used to create a cookie. The cookie can contain the token itself, along with a device id, a user id (usually provided by the online store), an item id, and a time stamp.

If the user does not decide to purchase the song, the user can close out of the purchase interface of the online store and return directly to the primary content.

If the user does decide to purchase the song, the client terminal communicates with the online store to complete the transaction. The client terminal also sends the cookie to the online store so that the online store can match the downloaded content with the invitational content that directed the user to purchase the item. By this method, the online store is able to accurately and reliable track a conversion of an item of invitational content into a sale.

In some embodiments, when a purchase is made, the client terminal sends all of its stored cookies. In this way, if a purchase is made at later time, the online store can still attempt to match the purchase to an item of invitational content and record the conversion.

Using this method of recording conversions, the online store is also able to track when an item of invitational content leads to a conversion of a related, but different, item than the item linked to by the invitational content. For example, the invitational content can invite a user to purchase a song, but the user purchases an album containing that song. Such a transaction can also be counted as a conversion. Likewise, if the user purchases a song and an album, the invitational content can be associated with more than one conversion.

Once the conversions are identified, the online store can package this data and send it to the content delivery system to provide feedback on the success of the invitational content.

In short, by transferring the token which accurately identifies the item of invitational content to the client terminal and then to the online store, more detailed and accurate conversion accounting and reporting is enabled. Additionally, since the online store is reporting conversions to the content delivery system, all conversions can be accounted for as they happen.

The examples provided above are merely illustrative of some of the ways in which the user's profile is used to inform decisions to retarget content such as invitational content.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary configuration of devices and a network;

FIG. 2 illustrates an example of content from one of primary content providers being presented in combination with invitational content form one of the secondary content providers;

FIG. 3 illustrates an exemplary user interface for allowing a user to purchase or download a product outside of the content from the primary content provider while the user experience maintains the appearance of being within content from the primary content providers;

FIG. 4 is a flowchart illustrating steps in an exemplary method for tracking invitational content conversions;

FIG. 5 presents a table illustrating the tracking of album and song conversions;

FIG. 6 presents a table illustrating the tracking of movie purchases and movie rentals and which formats were purchased/rented;

FIG. 7 is a table illustrating multiple conversions being assigned to one item of invitational content; and

FIG. 8 illustrates an exemplary system embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. The present disclosure addresses the need in the art for improved methods of selecting invitational content presented to a user based on the user's interactions with previously presented invitational content.

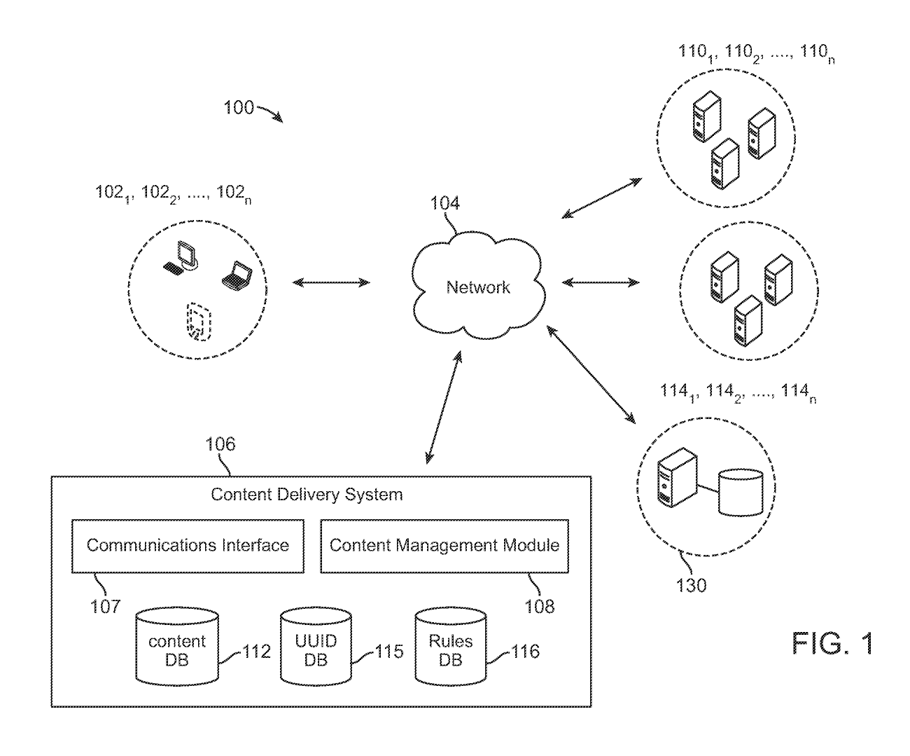

The presently disclosed system and method is particularly useful for assembling and delivering targeted content to a user. An exemplary system configuration 100 is illustrated in FIG. 1 wherein electronic devices communicate via a network for purposes of exchanging content and other data. The system can be configured for use on a local area network such as that illustrated in FIG. 1. However, the present principles are applicable to a wide variety of network configurations that facilitate the intercommunication of electronic devices. For example, each of the components of system 100 in FIG. 1 can be implemented in a localized or distributed fashion in a network.

In system 100, a content package is delivered to user terminals 102₁ . . . 102ₙ (collectively “102”) connected to a network 104 by direct and/or indirect communications with a content delivery system 106. In particular, the content delivery system 106 receives a request for an electronic content, such as a web page, an application, or media, etc., from one of user terminals 102. Thereafter, the content delivery system 106 assembles a content package in response to the request and transmits the assembled content package to the requesting one of user terminals 102. In some embodiments, the server has preassembled the content package before the request is received. The content in the assembled content package can include text, graphics, audio, video, executable code or any combination thereof. Further, the assembled content packages can include invitational content designed to inform or elicit a pre-defined response from the user and that can vary over time. The content delivery system can include a communications interface 107 to facilitate communications with the user terminals 102 and any other components familiar to those of ordinary skill in the art.

The content delivery system 106 includes a content management module 108 that facilitates generation of the assembled content package that includes invitational content. Specifically, the content management module can combine content from one or more primary content providers 110₁ . . . 110ₙ (collectively “110”) and content from one or more secondary content providers 114₁ . . . 114ₙ (collectively “114”) to generate the assembled content package for the user terminals 102. In some embodiments, the content management module can create a package from only secondary content, or only secondary content. The package need not contain both primary and secondary content.

Although, primary and secondary providers 110, 114 are presented herein as discrete, separate entities, this is for illustrative purposes only. In some cases, the primary and secondary providers 110, 114 can be the same entity. Thus, a single entity may define and provide both primary and secondary content. Although, both the primary and secondary content can comprise invitational content, in most instances, the secondary content will comprise the invitational content portion.

For example, in the case of a web page delivered to a requesting one of user terminals 102, the content management module 108 can assemble a content package by requesting the data for the web page from one of the primary content providers 110 maintaining the web page. Then the time-varying invitational content on the web page, which is provided by the secondary content providers 114, is obtained according to the arrangement between the primary and secondary content providers 110 and 114. For example, the invitational content from the secondary providers 114 can be selected based on a guaranteed number of impressions. Alternatively, the invitational content from the secondary providers 114 can be selected based on the context of the web page. In another example arrangement, the primary content can be sent separately, from a source other than the content delivery system disclosed here, or the primary content can have been previously downloaded and cached on the user terminal 102 requesting the content. In such instances, the content delivery system can send a content package containing time-varying invitational content for use, or display with, or related to, the primary content. However, any other arrangements and configuration for selecting invitational content from the secondary providers 110 can also be used.

Although the content management module 108 can be configured to request that data be sent directly from content providers 110 and 114, a cached arrangement can also be used to improve performance of the content delivery system 106 and improve overall user experience. That is, the content delivery system 106 can include a content database 112 for locally storing/caching content maintained by content providers 110 and 114. The data in the content database 112 can be refreshed or updated on a regular basis to ensure that the content in the database 112 is up to date at the time of a request from a user terminal. However, in some cases, the content management module 108 can be configured to retrieve data directly from content providers 110 and 114 if the metadata associated with the data in content database 112 appears to be outdated or corrupted.

In the various embodiments, the content delivery system 106 can also include a unique user identifier (UUID) database 115 that can be used for managing sessions with the various user terminal devices 102. The UUID database 115 can be used with a variety of session management techniques. For example, the content delivery system 106 can implement an HTTP cookie or any other conventional session management method (e.g., IP address tracking, URL query strings, hidden form fields, window name tracking, authentication methods, and local shared objects) for user terminals 102 connected to content delivery system 106 via a substantially persistent network session. However, other methods can be used as well. For example, in the case of handheld communications devices, e.g. mobile phones, smart phones, tablets, or other types of user terminals connecting using multiple or non-persistent network sessions, multiple requests for content from such devices may be assigned to a same entry in the UUID database 115. Such an assignment can be provided by analyzing requesting device attributes in order to determine whether such requests can be attributed to the same device. Such attributes can include device or group-specific attributes.

As described above, content maintained by the content providers 110 and 114 can be combined and/or presented according a predefined arrangement between the two content providers, which can be embodied as a set of rules. In an arrangement where the content delivery system assembles the content package from multiple content providers, these rules can be stored in a rules database 116 in content delivery system 106 and content management module 108 can be configured to assemble the content package for user terminals 102 based on these rules. The rules can specify how to select content from secondary content providers 114 and the primary content providers 110 in response to a request from one of user terminals 102. For example, in the case of a web page maintained by one of primary providers 110 and including variable advertisement portions, the rules database 116 can specify rules for selecting one of the secondary providers 114. The rules can also specify how to select specific content from the selected one of secondary providers 114 to be combined with the content provided by one of primary providers 110. Once assembled, the assembled content package can be sent to a requesting one of user terminals. However, the content package is not limited to the content from content providers 110 and 114. Rather, the content package can include other data generated at the content delivery system 106.

As described above, arrangements between the content providers 110 and 114 can result in content from one of primary content providers 110 being combined with invitational content from one or more of secondary content providers 114, based on the rules database 116. Although the rules database 116 can be accessed each time a request is received from one of user terminals 102, such a configuration can limit performance. Therefore, in many cases, the rules in rules database 116 are used to define at least one pool of invitational content from the secondary providers 114. Thus, when the content management module 108 assembles a content package, the content management module 108 first constructs and/or retrieves the pool. Thereafter, the content management module 108 can select an invitational content from one of the secondary content providers from the pool and form the assembled content package.

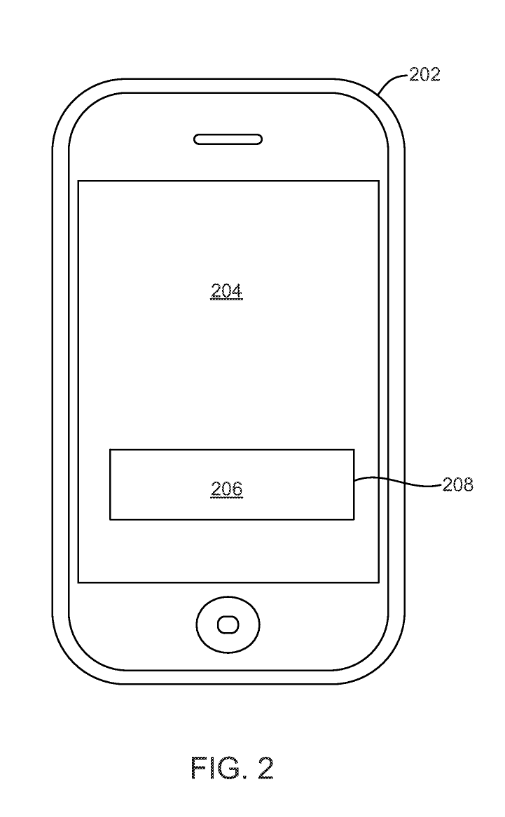

FIG. 2 illustrates an example of content from one of primary content providers 110 being presented in combination with invitational content from one of the secondary content providers 114. As illustrated, the device 202 is a handheld computing device, for example, a smart phone, e.g., an IPHONE, by Apple Inc. of Cupertino, Calif. However, the device 202 can be any computing device such as a personal computer, laptop, tablet or personal media-playing device; even a household appliance having a processor and a display can be used with the present technology.

The content from one of primary content providers 204 can be any application that reserves a view 208 or a window or a frame to display an item of invitational content 206 from one of the secondary content providers. In some embodiments, the view has a standard dimension that is consistent across all potential primary applications. In some embodiments, the view 208 occupies about ten percent of the available screen area. Of course, the invitational content can occupy any desired portion of the primary application. However, the area of the targeted application should not be so large as to obscure or detract from the content provided by the primary content providers, yet the invitational content should be large enough to view and interact with.

The invitational content 206 can be any application having content that is created with an audience in mind and can be targeted to that audience. For example, the application can be a game for children; a web application targeted at sports fans; or an advertisement for home improvement products targeted at home owners. In some preferred embodiments, the invitational content 206 can have some relationship to the content from the primary content providers 204, such as a similarity in the target demographic for the audiences of both applications or in the nature of the content of the applications, etc.

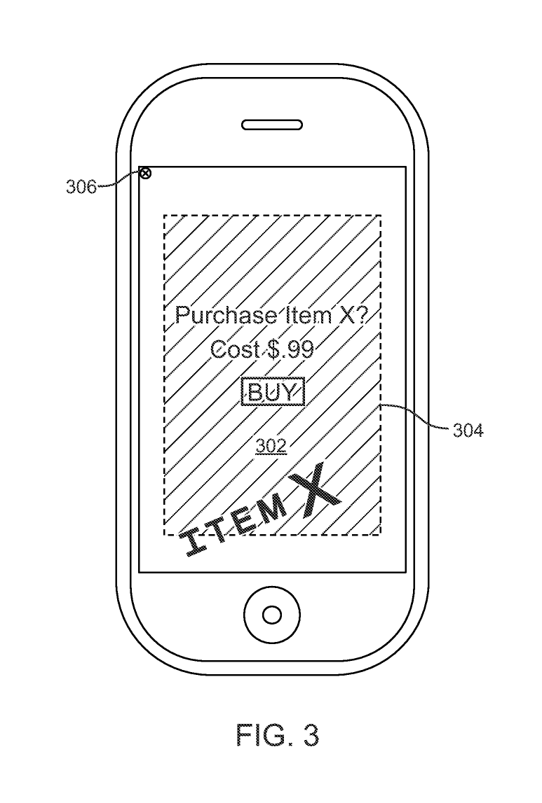

FIG. 3 illustrates an exemplary user interface for allowing a user to purchase or download a product outside of content 302 from the primary content provider while the user experience maintains the appearance of being within content 302 from the primary content providers. Such an interface can appear if a user clicks on the invitational content 206 in FIG. 2. As illustrated, a purchase interface 304 is inviting a user to purchase ITEM X (a hypothetical item for purchase). The purchase interface 304 is further shown overlaid the targeted application. In some embodiments, the purchase interface 304 is translucent or has transparent portions so that the content from the primary content provider 302 remains at least partially visible through the purchase interface. While the purchase interface 304 looks like it is part of the content from the primary content provider 302, it is really an extension of an online store. As an example, ITEM X could be a media item such as a movie or music, which is available for purchase from an online store, such as ITUNES, by Apple Inc., of Cupertino, Calif. In such an example, the invitational content could be a game or video or advertisement relating to the media item. The purchase interface is a local extension of the online store and can be used to allow the user to purchase the media item from the store.

If the user decides not to purchase the item, the user can click on the close window icon 306 and be returned to the content from the primary content provider.

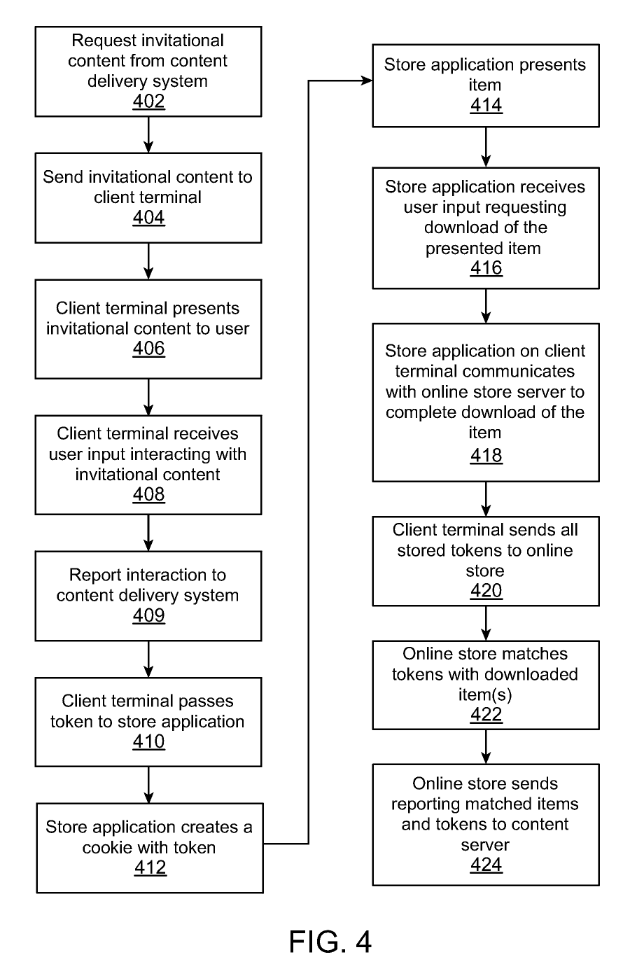

FIG. 4 is a flowchart illustrating steps in an exemplary method for tracking invitational content conversions. For the sake of clarity, this method is discussed in terms of an exemplary system such as is shown in FIG. 1. Although specific steps are shown in FIG. 4, in other embodiments a method can have more or less steps than shown.

One of the user terminals 102 requests (402) invitational content from the content delivery system 106. Suitable software being executed by the user terminal causes the user terminal to make the request. In some embodiments, the requesting software can be the operating system running on the device, but often an application supplied by one of the primary content providers 110 and running on the user terminal requests the invitational content.

The content delivery system 106 determines the appropriate invitational content stored in the content database 112 to service the request and sends (404) the invitational content to the client device 102. As described above, the content delivery system can employ a variety of logic or rules (rules database 116) to determine the most suitable content to send to the client device 102.

Along with the invitational content, the content delivery system can also send data identifying the invitational content. In one embodiment, the data is a token that can identify the invitational content by an identification code or other data. In some embodiments, the invitational content selected by the server can be associated with a larger group of invitational content and, in such instances, the token can identify the group of content selected as well as the individual item selected. In terms of a more concrete example, the invitational content can be an application selected from a genus group of applications. Each application within the genus can be largely similar, but the specific application, equivalent of the species in a genus-species relationship, can differ from the other applications in the genus by a minor variation. In some contexts, each variation is termed an impression. In such an example, the token can identify the genus and the species associated with the invitational content. In some embodiments, the token can also identify other relevant items of information.

After the invitational content is downloaded, the software running on the client terminal that requested the invitational content can present (406) the invitational content to the user. As discussed above, in some embodiments of the invitational content, the invitational content is adapted to elicit a user response(s).

When the client terminal 102 receives (408) a user input interacting with the invitational content, the client terminal can report (409) such interaction to the content delivery system 106. The reported interaction can include any recordable data regarding the user's interaction with the invitational content, including but not limited to mouse swipes, gestures, clicks, typing, etc.

If the client terminal 102 receives user input interacting with the invitational content in the form of the desired-elicited response, which in this instance is to interact with another application by following a link from the invitational content to the other application, the invitational content passes (410) the token earlier received from the server to the other application along with potentially additional information.

By way of example, the other application is a software application related to an online store and the desired-elicited response is to download a file from the online store, but the other application could be any application for any purpose and the desired-elicited response could be similarly variable. Continuing with the example of an online store, the online-store application on the client terminal creates (412) a cookie. The cookie stores the token received from the invitational content along with a unique item identifier, a unique device identifier, and a time stamp. The unique item identifier identifies the item to be downloaded in the online store and the online-store application can be identified by the aforementioned link from the invitational content to the online-store application.

The online-store application presents (414) the item to be downloaded. After the user device receives a user input instructing the store application to download (416) the presented item, the client terminal 102 communicates with the online store 130, which processes (418) the download transaction.

In some instances, the user might not download the item presented by the online-store application. In such instances the method can terminate but the cookie stored by the online-store application will remain stored on the client terminal. In some embodiments, the cookie will remain stored for a limited period of time, e.g., a month, a week, a day, an hour, etc. In some embodiments, the number of cookies that can be stored can be limited to prevent unreasonable use of disk space. In some embodiments, information can be deleted from some cookies to reduce the size of the cookie while retaining more essential information. For example, the token can be deleted from the cookie while maintaining the device ID and the item identifier, although deletion of such information can make the conversion tracking less accurate.

Assuming the user did download the item presented by the online-store application, the client terminal 102 can upload (420) all of the tokens stored within the cookies to the online store 130. The upload (420) can be contemporaneous with the request to download (418) the item or afterwards.

After the tokens have been received by the online store 130, the store attempts to match (422) the tokens with the downloaded item(s). Any matches are recorded and sent (424) to the content delivery system 106. In some embodiments, the record of the matches can be an extensible markup language (XML) file.

In sending the record of matches to the content delivery system 106, the content delivery system can receive an accurate record of all conversions that are associated with a given item of invitational content because the matched token specifically identifies the item of invitational content.

The online store 130 can collect data across multiple users or devices before reporting the data to the content delivery system 106, or it can send reports for each user.

A significant advantage of the presently described technology is the conversion tracking is more accurate. Since past systems required execution of code embedded in either the invitational content or within the downloaded item, many opportunities existed for a conversion to fail to be reported. For example, if a user downloaded an item, but never viewed the item, the code within the item for reporting the conversion would not be executed and that conversion would be lost. In the present system, conversions are accurately tracked and reported directly from the online store once the conversion is completed, thus, reducing or eliminating opportunities to fail to account for all conversions.

An additional advantage associated with the present technology is that the specific impression of invitational content can be related to the specific downloaded items, which presents the possibility for enhanced data reporting. For example, an item of invitational content can invite a user to download a video clip, but the user has the option of High-Definition (HD) or Standard Definition (SD) video. The present technology can track that a conversion took place and whether the user downloaded the HD or SD content. Likewise, an item of invitational content can invite a user to download a song from an album. If the user downloads the album instead of just the song, the method can track that a conversion took place and that the conversion was a download of the entire album.

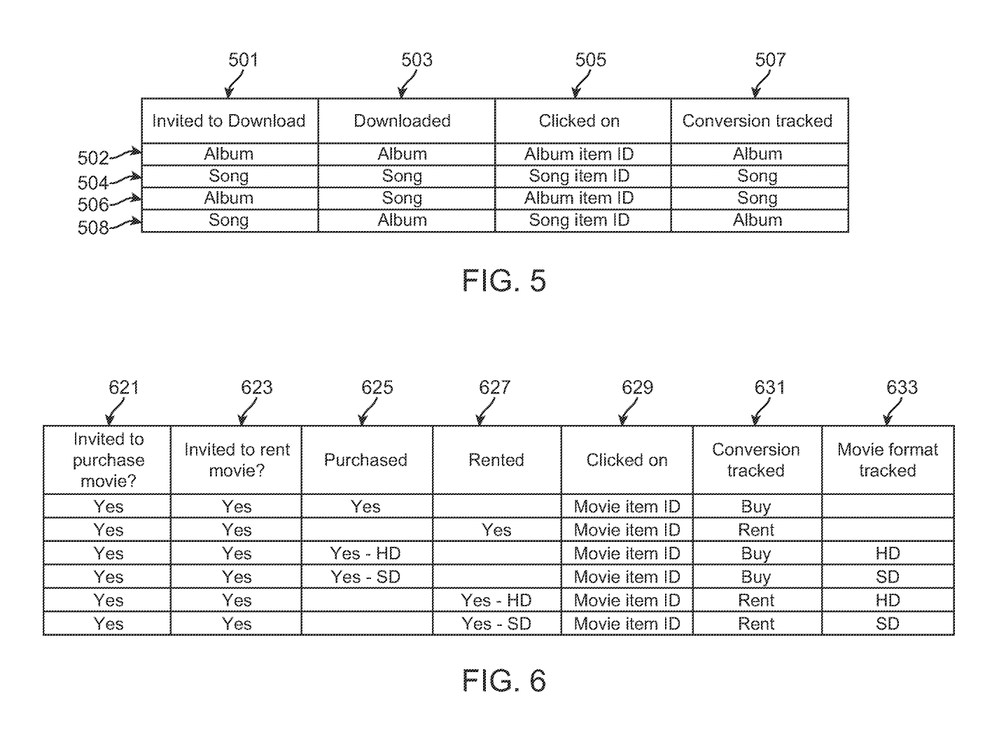

FIG. 5 presents a table illustrating the tracking of album and song conversions. Column 501 records whether the user was invited to download an album or a song. Column 503 records whether the user downloaded the album or song. Column 505 records that a user clicked on or provided some other input to the invitational content. Column 507 records the conversion, which in this case the conversion is recorded when the user has performed the invited action, i.e., downloaded content. In the table, rows 502 and 504 illustrate a conventional case where a user was presented with an invitation to download an album and then downloaded the album 502 or the user was presented with an invitation to download a song and the user downloaded the song 504. Rows 506 and 508 represent a non-conventional conversion wherein the user was invited to download an item and instead downloaded a different, but related item, in response to viewing the invitational content. For example row 506 illustrates the case where the system presented a user with an invitation to download an album, but the user downloaded a song instead. In conventional systems, this conversion likely would have been lost or at best associated with the wrong item of invitational content. Whereas, with the present technology, since the online store can compare the downloaded item directly with the token that identifies the specific item of invitational content, the system can record that the user was presented with an invitation to download an album, but a song was downloaded. The conversion can be tracked and recorded as is row 506. Row 508 illustrates the inverse case where a user was presented with an invitation to download a song, but downloaded an album instead.

FIG. 6 presents a table illustrating the tracking of movie purchases and movie rentals and which formats were purchased/rented. Column 621 records whether the user was presented with invitational content inviting the user to purchase the movie while 623 records whether the user was presented with invitational content inviting the user to rent the movie. Column 625 records whether the movie was purchased and Column 627 records whether the movie was rented. Column 629 records that the user clicked on invitational content for the movie and column 631 records that a conversion was completed. Column 633 records the format in which the conversion was completed. As illustrated, columns 631 and 633 record how the invitational content was converted. Column 631 notes whether the conversion was for a purchase or rental of the video content and Column 633 notes whether the purchase or rental was in HD or SD.

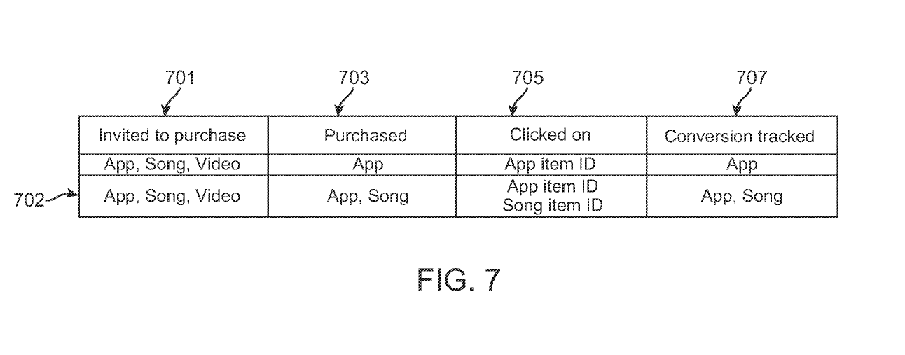

FIG. 7 is a table illustrating multiple conversions being assigned to one item of invitational content. Column 701 illustrates the content a user is invited to download by the same item of invitational content. In other words, the item of invitational content captured in this table invites a user to download an application (App), a Song and a Video. Column 703 illustrates which items were actually purchased. Column 705 records which items the user clicked on. Column 707 illustrates the conversions recorded. As illustrated in Row 702, the system can record multiple conversions and multiple clicks based on the same item of invitational content. In the example illustrated in Row 702, a user was invited to purchase an App, a Song and a Video and actually purchases the App and Song. The item of invitational content can then be credited with two conversions. In a conventional system the second conversion likely would have been lost or credited to a different item of invitational content. In contrast, in the present technology conversions are directly linked through the token to the specific item of invitational content which is responsible for the conversion.

It should be appreciated that the above examples are merely for illustration and that the present technology provides for more detailed and accurate recording of conversions for a great variety of data. This, in turn, allows more detailed and accurate reports which assist content providers and the content delivery system in evaluating the performance of the invitational content and the content delivery system.

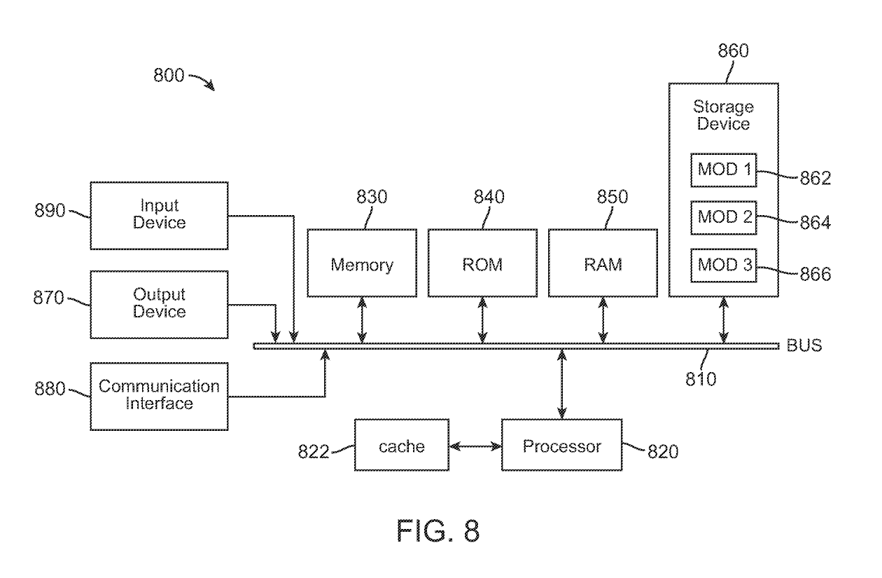

FIG. 8 is an exemplary system 800 for implementing the present technology. It should be appreciated that several or many systems 800 can work together to implement the technology. In some embodiments, the system 800 can be a client terminal, a content delivery system, a content provider, online store, etc.

The system 800 includes a general-purpose computing device 800, including a processing unit (CPU or processor) 820 and a system bus 810 that couples various system components including the system memory 830 such as read only memory (ROM) 840 and random access memory (RAM) 850 to the processor 820. The system 800 can include a cache 822 of high speed memory connected directly with, in close proximity to, or integrated as part of the processor 820. The system 800 copies data from the memory 830 and/or the storage device 860 to the cache 822 for quick access by the processor 820. In this way, the cache 822 provides a performance boost that avoids processor 820 delays while waiting for data. These and other modules can be configured to control the processor 820 to perform various actions. Other system memory 830 may be available for use as well. The memory 830 can include multiple different types of memory with different performance characteristics. It can be appreciated that the disclosure may operate on a computing device 800 with more than one processor 820 or on a group or cluster of computing devices networked together to provide greater processing capability. The processor 820 can include any general purpose processor and a hardware module or software module, such as module 1 862, module 2 864, and module 3 866 stored in storage device 860, configured to control the processor 820 as well as a special-purpose processor where software instructions are incorporated into the actual processor design. The processor 820 may essentially be a completely self-contained computing system, containing multiple cores or processors, a bus, memory controller, cache, etc. A multi-core processor may be symmetric or asymmetric.

The system bus 810 may be any of several types of bus structures including a memory bus or memory controller, a peripheral bus, and a local bus using any of a variety of bus architectures. A basic input/output (BIOS) stored in ROM 840 or the like, may provide the basic routine that helps to transfer information between elements within the computing device 800, such as during start-up. The computing device 800 further includes storage devices 860 such as a hard disk drive, a magnetic disk drive, an optical disk drive, tape drive or the like. The storage device 860 can include software modules 862, 864, 866 for controlling the processor 820. Other hardware or software modules are contemplated. The storage device 860 is connected to the system bus 810 by a drive interface. The drives and the associated computer readable storage media provide nonvolatile storage of computer readable instructions, data structures, program modules and other data for the computing device 800. In one aspect, a hardware module that performs a particular function includes the software component stored in a non-transitory computer-readable medium in connection with the necessary hardware components, such as the processor 820, bus 810, display 870, and so forth, to carry out the function. The basic components are known to those of skill in the art and appropriate variations are contemplated depending on the type of device, such as whether the device 800 is a small, handheld computing device, a desktop computer, or a computer server.

Although the exemplary embodiment described herein employs the hard disk 860, it should be appreciated by those skilled in the art that other types of computer readable media which can store data that are accessible by a computer, such as magnetic cassettes, flash memory cards, digital versatile disks, cartridges, random access memories (RAMs) 850, read only memory (ROM) 840, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 800, an input device 890 represents any number of input mechanisms, such as a microphone for speech, a touch-sensitive screen for gesture or graphical input, keyboard, mouse, motion input, speech and so forth. An output device 870 can also be one or more of a number of output mechanisms known to those of skill in the art. In some instances, multimodal systems enable a user to provide multiple types of input to communicate with the computing device 800. The communications interface 880 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 820. The functions these blocks represent may be provided through the use of either shared or dedicated hardware, including, but not limited to, hardware capable of executing software and hardware, such as a processor 820, that is purpose-built to operate as an equivalent to software executing on a general purpose processor. For example, the functions of one or more processors presented in FIG. 8 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 840 for storing software performing the operations discussed below, and random access memory (RAM) 850 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 800 shown in FIG. 8 can practice all or part of the recited methods, can be a part of the recited systems, and/or can operate according to instructions in the recited non-transitory computer-readable storage media. Such logical operations can be implemented as modules configured to control the processor 820 to perform particular functions according to the programming of the module. For example, FIG. 8 illustrates three modules Mod1 862, Mod2 864 and Mod3 866 which are modules controlling the processor 820 to perform particular steps or a series of steps. These modules may be stored on the storage device 860 and loaded into RAM 850 or memory 830 at runtime or may be stored as would be known in the art in other computer-readable memory locations.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

1. A method comprising:
receiving a request for an item of invitational content from an application provided by a primary content provider;
sending an item of invitational content and a token having data identifying the item of invitational content in response to the request for an item of invitational content, the item of invitational content including a link to an online store which identifies an item in the online store;
receiving a reporting file from an online store reporting a conversion of the item of invitational content into a purchase or download of the linked item in the online store, the conversion having been identified by a matching of the token with the purchase or download of the linked item.

2. The method of claim 1, wherein the request for an item of invitational content includes an identification of the application provided by the primary content provider and a user.

3. The method of claim 2, wherein the invitational content sent is selected by a content delivery system based on the application and the user identification.

4. The method of claim 1, wherein the link identifies multiple items in the online store.

5. The method of claim 4, wherein the reporting file reports multiple conversions of the item of invitational content by matching a single token with purchases or downloads of the multiple items.

6. The method of claim 1, wherein the reporting file further reports a user identification associated with the conversion.

7. The method of claim 6, wherein the reporting file reports multiple conversions associated with multiple users and multiple transactions.

8. A system comprising:
a content delivery server configured to transmit invitational content and further configured to receive feedback data related to the transmitted invitational content;
a client device configured to receive invitational content from the content delivery server and further configured to present the invitational content to a user; and
a transaction server configured to process a transaction request received from the client device, and further configured to receive data identifying one or more items of invitational content that were presented to a user from the client device, and further configured to match the processed transaction with a specific item of invitational content that was present to the user, and further configured to provide feedback to the content delivery server in the form of data matching the processed transaction with the specific item of invitational content.

9. The system of claim 8, wherein the content delivery server transmits the invitational content in response to receiving a request for invitational content from the client device.

10. The system of claim 8, wherein the client device is configured to execute a primary content application which requests invitational content from the content delivery server.

11. The system of claim 8, wherein the transaction request is made as a result of clicking on the invitational content, which includes an embedded link to the item on the transaction sever.

12. The system of claim 11, wherein the processed transaction is the sale or download to the client terminal of an item on the transaction server.

13. The system of claim 8, wherein the invitational content includes an embedded link to multiple items on the transaction server.

14. The system of claim 13, wherein the transaction server is configured to process multiple transactions by selling or downloading multiple items to the client terminal, the transaction server being further configured to match each of the multiple transactions to the same item of invitational content.

15. A computer implemented method comprising:
processing a transaction that was initiated by a transaction request received from a client device;
receiving, from the client device, data identifying one or more items of invitational content that were presented to a user by the client device, before the client device made the transaction request;
matching the processed transaction to a specific item of invitational content selected from the one or more items of invitational content; and
reporting the processed transaction matched with the specific item of invitational content to a content delivery system.

16. The computer implemented method of claim 15, wherein the transaction request is a request to purchase a media item.

17. The computer implemented method of claim 16, wherein the processed transaction is the completed purchase of the media item.

18. The computer implemented method of claim 15, wherein the method is executed on an online store.

19. The computer implemented method of claim 17, wherein each of the one or more items of invitational content includes a link to an item in the online store.

20. The computer implemented method of claim 15, wherein the data identifying one or more items of invitational content that were presented to a user by the client device is a token including an identification code assigned by the content delivery system that identifies each item of invitational content to the content delivery system.

21. The computer implemented method of claim 15, wherein the processed transaction is two or more processed transactions each matched to the same specific item of invitational content.

22. A non-transitory computer-readable medium having computer-readable code stored thereon for causing a computer to perform a method comprising:
receiving a request for an item of invitational content from an application provided by a primary content provider;
sending an item of invitational content and a token having data identifying the item of invitational content in response to the request for an item of invitational content, the item of invitational content including a link to an online store which link identifies an item in the online store;
receiving a reporting file from an online store reporting a conversion of the item of invitational content into a purchase or download of the linked item in the online store, the conversion having been identified by a matching of the token with the purchase or download of the linked item.

23. The non-transitory computer-readable medium of claim 22, wherein the request for an item of invitational content includes an identification of the application provided by the primary content provider and a user.

24. The non-transitory computer-readable medium of claim 23, wherein the invitational content sent is selected by a content delivery system based on the application and the user identification.

25. The non-transitory computer-readable medium of claim 22, wherein the link identifies multiple items in the online store.

26. The non-transitory computer-readable medium of claim 25, wherein the reporting file reports multiple conversions of the item of invitational content by matching a single token with purchases or downloads of the multiple items.

27. The non-transitory computer-readable medium of claim 22, wherein the reporting file further reports a user identification associated with the conversion.

28. The non-transitory computer-readable medium of claim 27, wherein the reporting file reports multiple conversions associated with multiple users and multiple transactions.
